(19) United States
(12) Patent Application Publication
(10) Pub. No.: US 2009/0251759 A1
(43) Pub. Date: Oct. 8, 2009

(54) Materials, thin films, optical filters, and devices including same

(76) Inventors: Lawrence H. Domash, Conway, MA (US); Seth Coe-Sullivan, Belmont, MA (US); Jouathan S. Steckel, Cambridge, MA (US)

Correspondence Address: Martha Ann Finnegan;QD Vision, Inc., 4th Floor, 313 Pleasant Street, Watertown, MA, 02472, US

(21) Appl. No.: 12/316,124

(22) Filed: Dec. 9, 2008

Related U.S. Application Data
(63) Continuation of application No. PCT/US2007/013761, filed on Jun. 8, 2007.
(60) Provisional application No. 60/812,267, filed on Jun. 10, 2006.
(60) Provisional application No. 60/804,430, filed on Jun. 10, 2006.

(30) Foreign Application Priority Data
Dec. 13, 2007 (WO) 2007/143227

(51) Int. Cl. G02F 1/17; H01B 1/00; G02B 5/22

(52) U.S. Cl. 359/288; 252/501.1; 359/359; 359/885; 977/813; 977/774

(57) ABSTRACT

A material is disclosed which possesses at least two of the following characteristics: (a) is optically transparent at a wavelength in the range from about 1500 nm to about 1560 nm; (b) has a 1/n dn/dt greater than that of silicon, (c) has an extinction coefficient, k, less than 10⁻³. In certain preferred embodiments, the material has the following characteristics: (a) 1/n dn/dt greater than that of silicon, and (b) an extinction coefficient, k, less than 10⁻³ at 1550 nm. In another aspect, a material comprising semiconductor nanocrystals, wherein the semiconductor nanocrystals are capable of displaying thermo-optic effects in bulk form and being sufficiently non-absorbing at a predetermined wavelength to be optically transparent at that wavelength is disclosed. In a preferred embodiment, the predetermined wavelength is about 1550 nm. Thin film, optical filters, and devices are also disclosed.

This application is a continuation of commonly owned PCT Application No. PCT/US2007/013761 filed 8 Jun. 2007, which was published in the English language as PCT Publication No. WO 2007/143227 on 13 Dec. 2007. The PCT Application claims priority from commonly owned U.S. Patent Application Nos.: 60/804,430 filed 10 Jun. 2006 and 60/812,267 filed 10 Jun. 2006. The disclosures of each of the above-listed applications are hereby incorporated herein by reference in their entireties.

### TECHNICAL FIELD OF THE INVENTION

The present inventions relates to the technical field of optical filters, tunable devices, and materials and thin films useful in the foregoing.

### BACKGROUND OF THE INVENTION

There is an unmet need in the fiber optic telecommunications industry, which is increasingly dependent on optically tunable components for WDM (Wavelength Division Multiplexed) networks in the 1500 nm band. An example involves the support of emerging applications in long haul, metro and access networks, and FTTx (Fiber To The Home or Enterprise).

In spite of extensive efforts over two decades, optically tunable passive components which meet all the exacting needs of telecom have proven surprisingly difficult to develop. MEMS (Micro Mechanical Electrical Systems) based tunable filters exist in the market, but are costly and inflexible in optical design. One of the few mechanisms of tunability which has proven to be practical for telecom devices is the thermo-optic effect, the change of refractive index with temperature. The simple principle of tuning an optical element through temperature is fundamentally inexpensive, involves no moving parts, and in principle can be applied to both of the main families of fiber optic devices, waveguides and thin film filters. The thermal tuning of sophisticated optical designs such as, for example, micro-ring resonators, arrayed waveguide gratings, or thin film filters, can preserve their sophisticated spectral designs. To date, MEMS can provide only the simplest Fabry-Perot filters.

In practice, thermal tuning is strictly limited by materials properties. While virtually all optical media show some temperature dependence of the index of refraction (n), for common materials such as fused silica or glass, the coefficients of thermal tunability are far too small to support wavelength tuning more than about 2-4 nm by means of reasonable temperature changes (100-200° C.), compared to the 32 nm which is considered the threshold of telecom “broad tunability.” Optical polymers and semiconductors are two classes of materials that have been exploited for their much larger thermal tunabilities. The largest known thermo-optic effects belong to certain polymers which are also relatively low in insertion loss at 1500 nm [H. Ma, A. K.-Y. Jen, L. R. Dalton, Polymer-Based Optical Waveguides: Materials, Processing, and Devices, Advanced Materials, v.14, pp. 1339-1365, 2002.] However, the best of these are fluorinated systems which are difficult to process. Also, the telecom industry has been reluctant to accept the long term stability of organic materials.

The most successful thermo-optic material in photonics applications to date is also the most readily available, silicon, which has excellent transparency at 1500 nm combined with a thermo-optic coefficient about 10× larger than for glasses or dielectrics. The amorphous version of silicon is equally thermally sensitive and can be deposited by PECVD as thin films, leading recently to thin film filters thermally tunable over >45 nm, but at the cost of a temperature range>400° C. [L. Domash, M. Wu, N. Nemchuck, E. Ma, “Tunable and Switchable Multiple-Cavity Thin Film Filter,” Journal of Lightwave Technology, Vol. 22, Issue 1, Page 126 (January 2004)]. The thermo-optic properties of various classes of materials are compared in Table I.

TABLE I
Thermo-optic properties of materials

| | | | | Transparent at |
|---|---|---|---|---|
| Class | Example | Index | 1/n dn/dT/° C. | 1500 nm? |
| Dielectrics | SiO2 | 1.45 | +7 × 10⁻⁶ | Yes |
| Polymers | Acrylate | 1.6 | −3 × 10⁻⁴ | Yes |
| Semiconductors | Silicon | 3.48 | +8 × 10⁻⁵ | Yes |
| Semiconductors | Germanium | 4.5 | +2 × 10⁻⁴ | No |

While silicon is a currently used as a thermo-optic material for telecom photonics and benefits from a mature processing technology for both thin films and waveguides (SOI—Silicon On Insulator), it is far from ideal. As a rule of thumb, silicon based devices working in the 1500 nm band tune about 1 nm for each 10° C. of temperature change (the tuning rate is not linear but increases about 50% from room temperature to 400° C.). To tune such a device over the full telecom C band of 32 nm, temperature changes on the order of 300° C. are required, posing severe challenges for device reliability. Thus silicon, the most thermo-optic of common optical materials in the near infrared, is not thermo-optic enough. Thermally tunable thin film filters based on amorphous silicon have been successful in applications where they are constantly being scanned (cycled in temperature), but not in a set-and-hold mode where they would be exposed to constant high temperatures over long periods of service. [Thermally tunable thin film filters are manufactured by Aegis Semiconductor, see white papers and specification sheets at www.aegis-semi.com.] Since processes of degradation behave like e^{-activation energy/kT}, even a moderate increase in dn/dT would be beneficial in reducing the extreme temperature requirements. Although semiconductors such as germanium possess twice the thermo-optic coefficient of silicon, Ge is strongly absorbent at 1500 nm. What is needed is a stable, processible new material with 1/n dn/dT greater than silicon but equally transparent at 1500 nm. Very little effort has been directed at improving semiconductor materials in this respect.

An ideal material for thermally tunable photonics would have the following properties:
Excellent transparency at 1500 nm; extinction coefficient k<5×10⁻⁶
Thermo-optic coefficient 1/n dn/dT>10⁻⁴/°C
Index n between 2.0 and 4.0
Stable, solid state, free of organics
Adaptable to processing:
   for patternable planar waveguides form (light propagation in the plane) or
   Adaptable to processing for thin film form for multilayer filters (light propagation normal to the plane)
Adaptable to integration with a complete array of functional devices including emitters and detectors

The fiber optic components industry is a rapidly evolving $12B global market with an increasing need for network flexibility, adaptability and intelligence. Emerging network architectures call for optical tunability, including functions such as ROADMs (Reconfigurable Add/Drop Multiplexers), wavelength selective switches, wavelength blockers, data filters, and optical performance monitors. Telecom system customers are demanding, and require such components to meet not only stringent requirements for performance and reliability (Telcordia qualification) but also aggressive price limits. For example, to find wide acceptance, a tunable narrowband optical filter to perform the function of selecting one wavelength channel from a WDM network for demultiplexing in a ROADM architecture would be required to display tunability over the full telecom C band (1528-1560 nm), insertion loss<0.9 dB, a shaped flat-topped passband, stable tuning properties which can be maintained at one setting for years without drift, a compact miniature package, and a selling price not to exceed $250 in quantity (Source: Kessler Market Intelligence). No tunable optical filter meeting all these requirements exists in the marketplace today.

Applicants are unaware of any naturally occurring semiconductor that meets the criteria for an ideal thermo-optic medium for photonic devices.

### SUMMARY OF THE INVENTION

In accordance with one aspect of the present invention, there is provided a material which possesses at least two of the following characteristics:

(a) is optically transparent at a wavelength in the range from about 1500 nm to about 1560 nm,

(b) has a 1/n dn/dt greater than that of silicon,

(c) has an extinction coefficient, k, less than 10⁻³.

In certain embodiments, the material comprises semiconductor nanocrystals. In certain preferred embodiments, the semiconductor nanocrystals are inorganic. In certain more preferred embodiments, the material comprises synthetic inorganic semiconductor nanocrystals. In certain most preferred embodiments, the material comprises colloidally synthesized inorganic semiconductor nanocrystals.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In certain preferred embodiments, the material is transparent at a wavelength of about 1550 nm.

In another aspect, the wavelength of the material could be as low as 1300 nm.

In accordance with another aspect of the present invention, there is provided a material comprising nanocrystals of a semiconductor material, wherein the nanocrystals are sufficiently non-absorbing at a predetermined wavelength to be transparent and wherein the semiconductor material, when in bulk form, is opaque at the predetermined wavelength. In certain preferred embodiments, the predetermined wavelength is about 1550 nm.

In certain embodiments, the nanocrystals can display a thermo-optic effect. Preferably, the nanocrystals display at least some of the thermo-optic effect observable in the semiconductor material when in bulk form.

In certain embodiments, the semiconductor nanocrystals are solution processible. In certain preferred embodiments, the semiconductor nanocrystals can be processed into a thin film. In certain embodiments, such thin film is suitable for use as a layer in a thin film optical filter. In certain embodiments, such thin film is suitable for use in a waveguide device.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In accordance with another aspect of the present invention, there is provided a material comprising nanocrystals of a semiconductor material, wherein the semiconductor nanocrystals are optically transparent at a predetermined wavelength due to quantum-size effects, and wherein the semiconductor material, when in bulk form, is light absorbing at the predetermined wavelength.

In certain detailed embodiments, semiconductor nanocrystals can be capable of displaying thermo-optic effects greater than those of silicon, while at the same time being transparent at a preselected wavelength of use, for example, at a wavelength of about 1500 nm or about 1550 nm. These embodiments are useful for applications such as fiber optic communications.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In accordance with another aspect of the invention, there is provided a thin film optical filter comprising a layer comprising semiconductors nanocrystals.

In certain embodiments, the semiconductor nanocrystals possess at least one of the following characteristics:

(a) the semiconductor nanocrystals are optically transparent at a wavelength in the range from about 1500 nm to about 1560 nm,

(b) the semiconductor nanocrystals have a 1/n dn/dt product greater than that of silicon,

(c) the semiconductor nanocrystals have an extinction coefficient, k, less than 10⁻³.

In certain preferred embodiments, the semiconductor nanocrystals possess two or three of the above listed characteristics.

In certain embodiments, the semiconductor nanocrystals are sufficiently non-absorbing to be transparent at a predetermined wavelength.

In certain other embodiments, the semiconductor nanocrystals exhibit a large thermo-optic effect and are sufficiently non-absorbing to be transparent at a predetermined wavelength.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In accordance with another aspect of the invention, there is provided a tunable thin film optical filter comprising a layer comprising semiconductors nanocrystals.

In certain embodiments, the semiconductor nanocrystals possess at least one of the following characteristics:

(a) the semiconductor nanocrystals are optically transparent at a wavelength in the range from about 1500 nm to about 1560 nm,

(b) the semiconductor nanocrystals have a 1/n dn/dt product greater than that of silicon,

(c) the semiconductor nanocrystals have an extinction coefficient, k, less than 10⁻³.

In certain preferred embodiments, the semiconductor nanocrystals possess two or three of the above listed characteristics.

In certain embodiments, the semiconductor nanocrystals are sufficiently non-absorbing at a predetermined wavelength to be transparent at the predetermined wavelength.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In accordance with another aspect of the invention, there is provided a Fabry-Perot filter. The filter comprises a sequence of alternating layers of semiconductor nanocrystals and a dielectric material deposited one on top of the other, said sequence of alternating layers forming a Fabry-Perot cavity structure including: a first multi-layer thin film interference structure forming a first mirror; a thin-film spacer layer deposited on a top surface of the first multi-layer thin-film interference structure; and a second multi-layer thin film interference structure deposited on a top surface of the thin-film spacer layer and forming a second mirror.

In certain embodiments, the spacer layer comprises spacer beads to provide an air gap. Such spacer beads can be constructed from glass, polymer, or other suitable material.

In accordance with other aspects of the invention, there are provided other devices, including, but not limited to, fiber optic devices and waveguide optical devices which include a material comprising semiconductor nanocrystals. In certain embodiments, the semiconductor nanocrystals are sufficiently non-absorbing at a predetermined wavelength to be optically transparent at that wavelength. In a preferred embodiment, the predetermined wavelength is about 1500 nm. In certain embodiments, the nanocrystals display thermo-optic effects.

The foregoing, and other aspects described herein all constitute embodiments of the present invention.

It is to be understood that both the foregoing general description and the following detailed description and figures are exemplary and explanatory only and are not restrictive of the invention as claimed. Other embodiments will be apparent to those skilled in the art from consideration of the specification and practice of the invention disclosed herein.

### BRIEF DESCRIPTION OF THE DRAWINGS

In the drawings:

FIG. 1 provides graphic representations of the thermo-optic coefficients of PbS and PbSe (bottom graph) and Ge, Si, InAs and CdTe (top graph);

FIG. 2 graphically depicts PbSe peak absorption vs. nanocrystal diameter for PbSe;

FIG. 3 is a schematic depiction of one example of a basic path to semiconductor nanocrystal synthesis useful for preparing materials in accordance with the invention; and

FIG. 4 schematically depicts coating a substrate using spin-casting.

The attached figures are simplified representations presented for purposed of illustration only; the actual structures may differ in numerous respects, including, e.g., relative scale, etc.

For a better understanding to the present invention, together with other advantages and capabilities thereof, reference is made to the following disclosure and appended claims in connection with the above-described drawings.

### DETAILED DESCRIPTION OF THE INVENTION

In accordance with one aspect of the present invention, there is provided a material which possesses at least two of the following characteristics:

(a) is optically transparent at a wavelength in the range from about 1500 nm to about 1560 nm,

(b) has a 1/n dn/dt greater than that of silicon,

(c) has an extinction coefficient, k, less than 10⁻³.

In certain embodiments, the material comprises semiconductor nanocrystals. In certain preferred embodiments, the semiconductor nanocrystals are inorganic. In certain more preferred embodiments, the material comprises synthetic inorganic semiconductor nanocrystals. In certain most preferred embodiments, the material comprises colloidally synthesized inorganic semiconductor nanocrystals.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In certain preferred embodiments, the material is transparent at a wavelength of about 1550 nm.

In accordance with another aspect of the present invention, there is provided a material comprising nanocrystals of a semiconductor material, wherein the nanocrystals are sufficiently non-absorbing at a predetermined wavelength to be transparent and wherein the semiconductor material, when in bulk form, is opaque at the predetermined wavelength. In certain preferred embodiments, the predetermined wavelength is about 1550 nm.

In certain embodiments, the nanocrystals can display a thermo-optic effect. Preferably, the nanocrystals display at least some of the thermo-optic effect observable in the semiconductor material when in bulk form.

In certain embodiments, the semiconductor nanocrystals are solution processible. In certain preferred embodiments, the semiconductor nanocrystals can be processed into a thin film. In certain embodiments, such thin film is suitable for use as a layer in a thin film optical filter. In certain embodiments, such thin film is suitable for use in a waveguide device.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In accordance with another aspect of the present invention, there is provided a material comprising nanocrystals of a semiconductor material, wherein the semiconductor nanocrystals are optically transparent at a predetermined wavelength due to quantum-size effects, and wherein the semiconductor material, when in bulk form, is light absorbing at the predetermined wavelength.

In certain detailed embodiments, semiconductor nanocrystals can be capable of displaying thermo-optic effects greater than those of silicon, while at the same time being transparent at a preselected wavelength of use, for example, at a wavelength of about 1500 nm or about 1550 nm. These embodiments are useful for applications such as fiber optic communications.

In certain embodiments, the semiconductors nanocrystals comprise lead. In certain other embodiments, the semiconductor nanocrystals comprise a lead chalcogenide. In certain detailed embodiments, the semiconductor nanocrystals comprise PbS, PbSe, PbTe, and/or alloys and/or mixtures thereof. In certain other embodiments, the semiconductor nanocrystals can comprises Cd based II-VI compounds, Zn based II-VI compounds, and/or alloys and/or mixtures thereof. In certain other embodiments, the semiconductor nanocrystals can comprise Ge.

In accordance with another aspect of the invention, there is provided a thin film optical filter comprising a layer comprising semiconductors nanocrystals.

The size of the nanocrystals of the semiconductor material is preferably engineered to preserve the thermo-optic properties observed in bulk form of the semiconductor material and to be sufficiently non-absorbing so as to be optically transparent at the predetermined wavelength. In certain embodiments, semiconductors nanocrystals comprise lead.

In accordance with another aspect of the invention, there is provided a thin film optical filter comprising a layer comprising semiconductors nanocrystals.

In accordance with another aspect of the invention, there is provided a tunable thin film optical filter comprising a mirror comprising a layer comprising semiconductors nanocrystals. In certain embodiments, the semiconductor material of the nanocrystals is capable of displaying large thermo-optic effects when in bulk form. In certain embodiments, the semiconductor nanocrystals are sufficiently non-absorbing at a predetermined wavelength so as to be optically transparent at that wavelength. In certain embodiments, the filter also comprises a heater film.

In certain preferred embodiments, the materials of the invention are solution processible. This can permit the formation of dense films of varying thicknesses. For example, dense films with thickness up to, for example, about 1.5 μm can facilitate thin film and waveguide device applications. In certain preferred embodiments, the thin film can have a thickness of about 0.5 μm.

Semiconductor nanocrystals (NCs) or quantum dots (QDs) (including, e.g., colloidal semiconductor nanocrystals) are nanometer sized, crystalline, particles of semiconductor material. In certain embodiments, molecules or ligands can be attached to semiconductor nanocrystal surfaces to facilitate their manipulation in solutions or dispersions. Such molecules or ligands can achieve favorable semiconductor nanocrystal/solvent or liquid interactions [Murray et al. (J. Am. Chem. Soc., 115:8706 (1993)]. Semiconductor nanocrystals can have sizes ranging from <1 nm in diameter), which, e.g., can be nearly molecular (<100 atoms), to >20 nm in diameter, which, e.g., can be made up of over 100,000 atoms. The intermediate regime between molecular and bulk semiconductor material is characterized by engineerable manipulation of optical properties of the semiconductor due to quantum mechanical effects. The origin of this effect, known as quantum confinement, comes about when the dimensions of the semiconductor nanocrystal become so small that the charge carriers' wavefunctions (Bohr radius) exceeds the radius of the semiconductor nanocrystal.

Preparation and manipulation of semiconductor nanocrystals are described, for example, in U.S. Pat. Nos. 6,322,901 and 6,576,291, and U.S. Patent Application No. 60/550,314, each of which is hereby incorporated herein by reference in its entirety. One method of manufacturing a semiconductor nanocrystal is a colloidal growth process. Colloidal growth occurs by injection an M donor and an X donor into a hot coordinating solvent. One example of a preferred method for preparing monodisperse semiconductor nanocrystals comprises pyrolysis of organometallic reagents, such as dimethyl cadmium, injected into a hot, coordinating solvent. This permits discrete nucleation and results in the controlled growth of macroscopic quantities of semiconductor nanocrystals. The injection produces a nucleus that can be grown in a controlled manner to form a semiconductor nanocrystal. The reaction mixture can be gently heated to grow and anneal the semiconductor nanocrystal. Both the average size and the size distribution of the semiconductor nanocrystals in a sample are dependent on the growth temperature. The growth temperature necessary to maintain steady growth increases with increasing average crystal size. The semiconductor nanocrystal is a member of a population of semiconductor nanocrystals. As a result of the discrete nucleation and controlled growth, the population of semiconductor nanocrystals that can be obtained has a narrow, monodisperse distribution of diameters. The monodisperse distribution of diameters can also be referred to as a size. Preferably, a monodisperse population of particles includes a population of particles wherein at least about 60% of the particles in the population fall within a specified particle size range. A population of monodisperse particles preferably deviate less than 15% rms (root-mean-square) in diameter and more preferably less than 10% rms and most preferably less than 5%.

The process of controlled growth and annealing of the semiconductor nanocrystals in a coordinating solvent that follows nucleation can also result in uniform surface derivatization and regular core structures. As the size distribution sharpens, the temperature can be raised to maintain steady growth. By adding more M donor or X donor, the growth period can be shortened. The M donor can be an inorganic compound, an organometallic compound, or elemental metal. Examples of M include cadmium, zinc, or lead. The X donor is a compound capable of reacting with the M donor to form a material with the general formula MX. X donors include, for example, chalcogenide donors, such as a phosphine chalcogenide, a bis(silyl) chalcogenide, dioxygen, an ammonium salt. Suitable X donors include dioxygen, bis(trimethylsilyl) selenide ((TMS)₂Se), trialkyl phosphine selenides such as (tri-noctylphosphine) selenide (TOPSe) or (tri-n-butylphosphine) selenide (TBPSe), trialkyl phosphine tellurides such as (tri-n-octylphosphine) telluride (TOPTe) or hexapropylphosphorustriamide telluride (HPPTTe), bis(trimethylsilyl)telluride ((TMS)₂Te), bis(trimethylsilyl)sulfide ((TMS)₂S), a trialkyl phosphine sulfide such as (tri-noctylphosphine) sulfide (TOPS), an ammonium salt such as an ammonium halide (e.g., NH4Cl), tris(trimethylsilyl) phosphide ((TMS)₃P), tris(trimethylsilyl) arsenide ((TMS)₃As), or tris(trimethylsilyl) antimonide ((TMS)₃Sb). In certain embodiments, the M donor and the X donor can be moieties within the same molecule.

A coordinating solvent can help control the growth of the semiconductor nanocrystal. The coordinating solvent is a compound having a donor lone pair that, for example, has a lone electron pair available to coordinate to a surface of the growing semiconductor nanocrystal. Solvent coordination can stabilize the growing semiconductor nanocrystal. Examples of coordinating solvents include alkyl phosphines, alkyl phosphine oxides, alkyl phosphonic acids, or alkyl phosphinic acids, however, other coordinating solvents, such as pyridines, furans, and amines may also be suitable for the semiconductor nanocrystal production. Examples of suitable coordinating solvents include pyridine, tri-n-octyl phosphine (TOP), tri-n-octyl phosphine oxide (TOPO) and trishydroxylpropylphosphine (tHPP). Technical grade TOPO can be used.

In other embodiments, colloidal growth can be carried out in a non-coordinating solvent.

Size distribution during the growth stage of the reaction can be estimated by monitoring the absorption or emission line widths of the particles. Modification of the reaction temperature in response to changes in the absorption spectrum of the particles allows the maintenance of a sharp particle size distribution during growth. Reactants can be added to the nucleation solution during crystal growth to grow larger crystals. For example, for CdSe and CdTe, by stopping growth at a particular semiconductor nanocrystal average diameter and choosing the proper composition of the semiconducting material, the emission spectra of the semiconductor nanocrystals can be tuned continuously over the wavelength range of 300 nm to 5 microns, or from 400 nm to 800 nm.

The particle size distribution of the semiconductor nanocrystals can be further refined by size selective precipitation with a poor solvent for the semiconductor nanocrystals, such as methanol/butanol as described in U.S. Pat. No. 6,322,901. For example, semiconductor nanocrystals can be dispersed in a solution of 10% butanol in hexane. Methanol can be added dropwise to this stirring solution until opalescence persists. Separation of supernatant and flocculate by centrifugation produces a precipitate enriched with the largest crystallites in the sample. This procedure can be repeated until no further sharpening of the optical absorption spectrum is noted. Size-selective precipitation can be carried out in a variety of solvent/nonsolvent pairs, including pyridine/hexane and chloroform/methanol. The size-selected semiconductor nanocrystal population preferably has no more than a 15% rms deviation from mean diameter, more preferably 10% rms deviation or less, and most preferably 5% rms deviation or less.

As discussed herein, the semiconductor nanocrystals can have ligands attached thereto.

In one embodiment, the ligands are derived from the coordinating solvent used during the growth process. The surface can be modified by repeated exposure to an excess of a competing coordinating group to form an overlayer. For example, a dispersion of the capped semiconductor nanocrystal can be treated with a coordinating organic compound, such as pyridine, to produce crystallites which disperse readily in pyridine, methanol, and aromatics but no longer disperse in aliphatic solvents. Such a surface exchange process can be carried out with any compound capable of coordinating to or bonding with the outer surface of the semiconductor nanocrystal, including, for example, phosphines, thiols, amines and phosphates. The semiconductor nanocrystal can be exposed to short chain polymers which exhibit an affinity for the surface and which terminate in a moiety having an affinity for a liquid medium in which the semiconductor nanocrystal is suspended or dispersed. Such affinity improves the stability of the suspension and discourages flocculation of the semiconductor nanocrystal.

The organic ligands can be useful in facilitating large area, non-epitaxial deposition of highly stable inorganic nanocrystals within a device.

More specifically, the coordinating ligand can have the formula:

(Y—)ₖ₋ₙ—(X)-(-L)ₙ

wherein k is 2, 3 or 5, and n is 1, 2, 3, 4 or 5 such that k−n is not less than zero; X is O, S, S═O, SO2, Se, Se═O, N, N═O, P, P═O, As, or As═O; each of Y and L, independently, is aryl, heteroaryl, or a straight or branched C2-12 hydrocarbon chain optionally containing at least one double bond, at least one triple bond, or at least one double bond and one triple bond. The hydrocarbon chain can be optionally substituted with one or more C1-4 alkyl, C2-4 alkenyl, C2-4 alkynyl, C1-4 alkoxy, hydroxyl, halo, amino, nitro, cyano, C3-5 cycloalkyl, 3-5 membered heterocycloalkyl, aryl, heteroaryl, C1-4 alkylcarbonyloxy, C1-4 alkyloxycarbonyl, C1-4 alkylcarbonyl, or formyl. The hydrocarbon chain can also be optionally interrupted by —O—, —S—, —N(Ra)—, —N(Ra)—C(O)—O—, —O—C(O)—N(Ra)—, —N(Ra)—C(O)—N(Rb)—, —O—C(O)—O—, —P(Ra)—, or —P(O)(Ra)—. Each of Ra and Rb, independently, is hydrogen, alkyl, alkenyl, alkynyl, alkoxy, hydroxylalkyl, hydroxyl, or haloalkyl. An aryl group is a substituted or unsubstituted cyclic aromatic group. Examples include phenyl, benzyl, naphthyl, tolyl, anthracyl, nitrophenyl, or halophenyl. A heteroaryl group is an aryl group with one or more heteroatoms in the ring, for instance furyl, pyridyl, pyrrolyl, phenanthryl.

A suitable coordinating ligand can be purchased commercially or prepared by ordinary synthetic organic techniques, for example, as described in J. March, Advanced Organic Chemistry, which is hereby incorporated by reference in its entirety.

Other ligands are described in U.S. patent application Ser. No. 10/641,292 for “Stabilized Semiconductor Nanocrystals”, filed 15 Aug. 2003, which is hereby incorporated herein by reference in its entirety.

Examples of semiconductor materials include, e.g., Pb chalcogenides and other Pb compounds (e.g., salts, etc.), Cd and Zn based II-VI semiconductors, Ge, etc.

PbS (and similarly PbSe, PbTe) colloidal semiconductor nanocrystals may be prepared using a solution-based organometallic path, using precursors such as lead oleate and bis(trimethylsilyl)sulfide (TMS). Temperature is used to control the desired growth rate and particle size. Oleic acid, a coordinating solvent, attaches to the surface of the semiconductor nanocrystal, preventing them from aggregating into bulk crystals; it passivates the surface, reducing non-radiative surface recombination. Nucleation occurs when the sulfur precursor is added to the lead oleate solution and continues until the temperature is lowered below a threshold value. After nucleation, the size of the semiconductor nanocrystals can be controlled by varying the concentration of the capping ligand, the injection temperature and time, growth temperature and time, and the molar ratio of oleic acid to lead to sulfur. When the semiconductor nanocrystals reach the desired size they are precipitated from the growth mixture by adding a polar solvent such as methanol and may then be redispersed in nonpolar solvents such as toluene. In most cases the goal of such size-effect engineering has been focused on the absorption peaks, however, here one interest is in the regions of transparency, which can be enhanced in the 1500 nm band as the semiconductor nanocrystals become smaller.

While it is possible to find semiconductors with dn/dT much larger than that of silicon, none combines this with low absorption at 1500 nm. The usable pathlength in the material (or in the case of thin film filters, the usable number of multiple passes governed by reflectivity of Fabry-Perot mirrors) is controlled by 1/k. Therefore a quality metric for thermo-optic materials is the fractional change in index n per ° C. at room temperature, multiplied by the transparency 1/k at 1500 nm; this product may be called the ‘thermo-optic efficiency’ or TOE.

TOE=Thermal index change per unit pathlength per ° C.≈(1/nk)dn/dT

TOE for silicon is about 20. A thermo-optic material with TOE with a value of 30 would significantly expand the usefulness of thermo-optic photonic devices by reducing the maximum operating temperature to a manageable level. Thermo-optic materials with TOE of 60 or more that can be prepared on a large scale would represent a significant advance in photonic materials.

As is well known, the complex refractive index n+ik for any medium is such that n(f) and k(f) are related by the Kramers-Kronig integral equation, where f is the optical frequency. This means that n can be calculated or estimated if the absorptance is known for a range of wavelengths, and changes in n due to changes in temperature can likewise be estimated if the thermal properties of spectral absorptances are known. In this way the theory of the thermo-optic effect including semiconductors was developed in a monograph by Ghosh [Ghosh, Handbook of Thermo-Optic Coefficients of Optical Materials, Academic Press, 1998], leading to the following expression for the dispersion of the n dn/dT product as a function of wavelength:

2ndn/dT=(n₀²−1)(−3αλ²/(λ²−λᵢ²)−1/E dE/dT λ⁴/(λ²−λᵢ²)²)

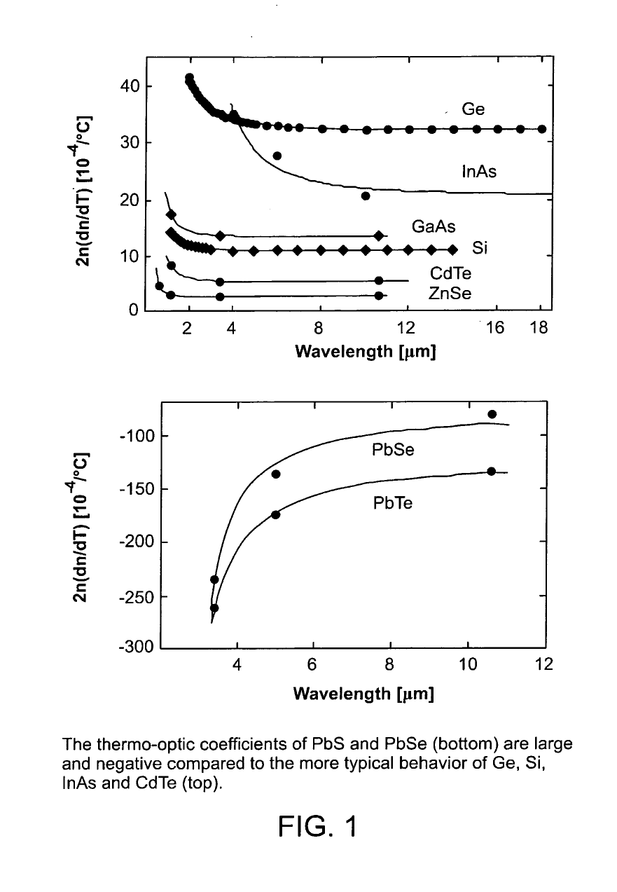

Here n₀ is the asymptotic index at very long wavelengths, α is the linear thermal expansion coefficient, λᵢ is the wavelength corresponding to the isentropic bandgap, and E is the excitonic bandgap in eV. The first term is the contribution of thermal expansion and is typically smaller than the second term, which relates to the thermal rate of change of the exitonic band gap. In most cases dE/dT is negative, making dn/dT positive, but in some cases, notably the lead salts, the change of bandgap with energy can be positive, producing a large negative dn/dT. Table II below and FIG. 1 summarize some materials of interest. The bulk properties of PbS and PbSe are particularly interesting since dn/dT (measured at 3.4 μm) is unusually large in absolute value compared to either Si or Ge.

TABLE II
Thermo-Optic Parameters of Semiconductors

| | | Bandgap, | Excitonic | dE/dT × 10⁻⁴ | Wavelength, | dn/dT × 10⁻⁴/ |
|---|---|---|---|---|---|---|
| Material | n₀ | eV | E, eV | eV/C. | μm | C. |
| Si | 3.42 | 1.11 | 3.38 | −5.4 | 1.5 | +1.8 |
| Ge | 4.0 | 0.67 | 1.36 | −3.7 | 3.0 | +4.4 |
| PbS | 4.1 | 0.37 | 1.13 | +5.2 | 3.4 | −21 |
| PbSe | 4.79 | 0.27 | 0.95 | +4.0 | 3.4 | −23 |

It can be useful to understand how the temperature dependent variation of the energy gap is likely to differ from the bulk in the case of semiconductor nanocrystals of various sizes. This has been studied for lead-salt semiconductor nanocrystals. See Olkhovets, Hsu, Lipovskii and Wise, Size-Dependent Temperature Variation of the Energy Gap in Lead-Salt Quantum Dots, Phys. Rev. Lett., 81, p. 539, 19 Oct. 1998., the disclosure of which is hereby incorporated herein by reference.

Early in semiconductor nanocrystal research, it was speculated that quantum confined systems would be nearly atom-like and therefore almost temperature insensitive compared to bulk semiconductors. (This was perceived as an advantage for light emitters whose colors would then be more stable.) Subsequently it was understood that temperature sensitivity is strongly dependent on exact nanocrystal sizes, tending toward the temperature dependence characteristic of bulk semiconductors for larger nanocrystals, and toward temperature independence in the limit of small, more quantum-confined nanocrystals, closer to the behavior of atom-like level structures. This transition has been found to take place over a narrow range of nanocrystal sizes. As reported by Olkhovets, et al., supra, for the case of PbS from 12-300° K, larger dots on the order of 8.5 nm show dE_{g}/dT comparable to that of the bulk material. By reducing the nanocrystal size to 4.5 nm however, the temperature dependence is reduced nearly ten-fold.

Thus a nanocrystal version of a semiconductor will lose its bulk thermo-optic properties if the semiconductor nanocrystals are too small. For the second important property of a preferred embodiment of a material of the invention with transparency at 1500 nm, however, the opposite trend is true since pushing the effective bandgap to larger values by confinement will move the absorptive resonances further away from the wavelength of interest in the near IR. Thus transparency at 1500 nm will best for the smallest semiconductor nanocrystals.

The Thermo-Optic Efficiency for the above-mentioned preferred embodiment of material comprising semiconductor nanocrystals, with transparency at 1500 nm, is therefore the product of two factors, one of which rises strongly and the other of which falls strongly with size, so the TOE therefor will have a maximum within the range of feasible nanocrystal sizes (possibly at one end of the range).

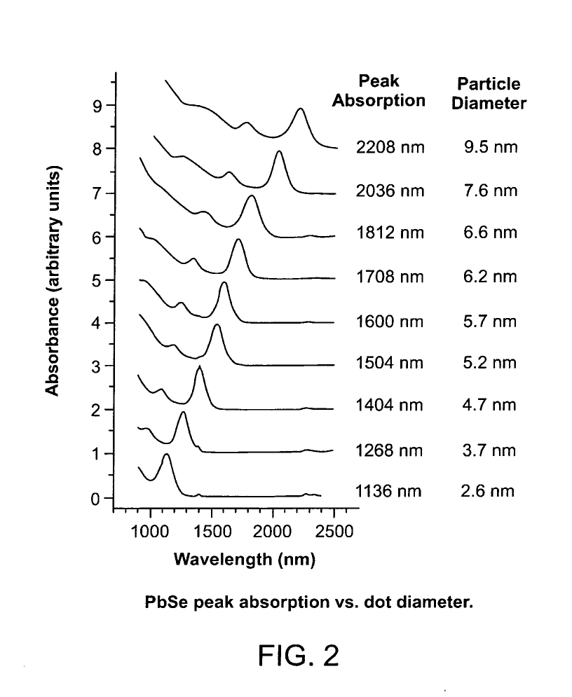

As described earlier, the lead salts have remarkably large dn/dT in bulk. The first requirement for particle size is to be large enough to preserve preferably most of the dn/dT effect, which according to the Cornell work cited earlier argues for nanocrystal sizes on the order of 6 nm or larger, and the second is to be small enough to produce transparency at 1500 nm. FIG. 2, reproduced from [Steckel, S. Coe-Sullivan, V. Bulovic, M. G. Bawendi, Adv. Mater. 15, 1862, 2003] graphically depicts PbSe peak absorption vs. nanocrystal diameter for PbSe. PbSe may be marginal for use in a tunable filter. However, based on the same considerations, it may be useful as transparent near-IR media with unusually small thermo-optic effects for stabilized rather than tunable devices. For example, very small semiconductor nanocrystals, transparent at the telecom band, with extremely small dn/dT, may be useful for temperature independent, passively stabilized devices of certain kinds which cannot presently make use of semiconductor ingredients without expensive thermo-electric stabilizers.

Additional information concerning PbSe semiconductor nanocrystals is included in the thesis of Jonathan S. Steckel, “The Synthesis of Inorganic Semiconductor Nanocrystalline Materials For the Purpose of Creating Hybrid Organic/Inorganic Light-Emitting Devices”, Massachusetts Institute of Technology, September, 2006, which is hereby incorporated herein by reference in its entirety.

For telecom applications, the thermo-optic film will be impractical unless it can be fabricated into functional devices. There are a variety of device paths known in the photonics art and a growing discussion of solution-processed semiconductor nanocrystal materials applied to photonics integration, including detectors, lasers, etc. that are expected to be suitable for telecom applications.

Two important design elements for function devices useful for telecom and other photonics applications include thickness control and patternability.

One broad class of applications relates to tunable thin film filters.

Tunable thin film filters (TTFFs) are free-space filters that admit beams of light, for example collimated light, and filter out specific wavelength or sets of wavelengths for transmission or reflection. The optical beams to be filtered are unguided except for input and output optics which extract them and insert them into waveguides such as optical fibers. A schematic block diagram of an example of an optical instrument including a TTFF is depicted in FIG. 1 of, and described in, U.S. Pat. No. 7,002,697, which is hereby incorporated herein by reference in its entirety. The material of the present invention would replace Si—H in such filter, with other design changes which would be readily identified and achieved by one of ordinary skill in the relevant art.

The main challenge in fabricating TTFFs is to provide extremely accurate film thicknesses for ¼ or ½ wave optical thicknesses. Solution-processing techniques have rarely been used for thin film filters because methods to track the deposition thicknesses in real time, which are well known for physical deposition processes, have yet to be developed. However, simple thin film thermally tunable filters could be produced with single active layers if the thin film reflectors that accompany them are provided by other techniques such as by evaporation, sputtering, or PECVD. More complex, multi-cavity thin film filters require the deposition of multilayers of alternating high and low index media, and the cavity layers must be matched to one another with a precision on the order of 10⁻⁴.

Additional information concerning devices, structures, systems, and other related techniques that may be useful in connection with practice of the invention are described in: U.S. Pat. No. 7,002,697 of Domash et al., issued Feb. 21, 2006 for “Tunable Optical Instruments”, U.S. Pat. No. 7,049,004 of Domash et al., issued May 23, 2006 for “Index Tunable Thin Film Interference Coatings”, R. Allen, “Uncooled Thermal Imaging Has Mass-Market Appeal”, ED Online ID #10742, Jul. 21, 2005 (Copyright 2006 Penton Media, Inc.) http://www.elecdesign.com/Articles/Index.cfm?AD=1&ArticleID=10742, L. H. Domash, Eugene Ma, Nikolay Nemchuk, Adam Payne, and Ming Wu, “Tunable Thin-Film Filters Based On Thermo-Optic Semiconductor Films”, http://www.aegis-semi.com/, (JUNE 2002—PHOTONICS NORTH); Lawrence H. Domash, Eugene Ma, Nikolay Nemchuk, Adam Payne, and Ming Wu, “Tunable Thin Film Filters”, http://www.aegis-semi.com/ (MARCH 2003—OSA OPTICAL FIBER CONFERENCE). The foregoing patents and publications are hereby incorporated herein by reference in their entireties.

Contact printing provides a method for applying a material to a predefined region on a substrate in a patterned or unpatterned arrangement. The predefined region is a region on the substrate where the material is selectively applied. The material and substrate can be chosen such that the material remains substantially entirely within the predetermined area. By selecting a predefined region that forms a pattern, material can be applied to the substrate such that the material forms a pattern. The pattern can be a regular pattern (such as an array, or a series of lines), or an irregular pattern. Once a pattern of material is formed on the substrate, the substrate can have a region including the material (the predefined region) and a region substantially free of material. In some circumstances, the material forms a monolayer on the substrate. The predefined region can be a discontinuous region. In other words, when the material is applied to the predefined region of the substrate, locations including the material can be separated by other locations that are substantially free of the material.

Contact printing can begin by forming a patterned or unpatterned mold. The mold has a surface with a pattern of elevations and depressions. The stamp can include planar and/or non-planar regions. A stamp is formed with a complementary pattern of elevations and depressions, for example by coating the patterned surface of the mold with a liquid polymer precursor that is cured while in contact with the patterned mold surface. The stamp can then be inked; that is, the stamp is contacted with a material which is to be deposited on a substrate. The material becomes reversibly adhered to the stamp. The inked stamp is then contacted with the substrate. The elevated regions of the stamp can contact the substrate while the depressed regions of the stamp can be separated from the substrate. Where the inked stamp contacts the substrate, the ink material (or at least a portion thereof) is transferred from the stamp to the substrate. In this way, the pattern of elevations and depressions is transferred from the stamp to the substrate as regions including the material and free of the material on the substrate. Microcontact printing and related techniques are described in, for example, U.S. Patent Nos. 5,512,131; 6,180,239; and 6,518,168, each of which is incorporated by reference in its entirety. In some circumstances, the stamp can be a featureless stamp having a pattern of ink, where the pattern is formed when the ink is applied to the stamp. See U.S. patent application Ser. No. 11/253,612, filed Oct. 21, 2005, which is incorporated by reference in its entirety.

Other materials, techniques, methods and applications that may be useful in connection with depositing a material including semiconductor nanocrystals are described in, U.S. Provisional Patent Application No. 60/792,170, of Seth Coe-Sullivan, et al., for “Composition Including Material, Methods Of Depositing Material, Articles Including Same And Systems For Depositing Material”, filed on 14 Apr. 2006; U.S. Provisional Patent Application No. 60/792,084, of Maria J. Anc, For “Methods Of Depositing Material, Methods Of Making A Device, And System”, filed on 14 Apr. 2006, U.S. Provisional Patent Application No. 60/792,086, of Marshall Cox, et al, for “Methods Of Depositing Nanomaterial & Methods Of Making A Device” filed on 14 Apr. 2006; U.S. Provisional Patent Application No. 60/792,167 of Seth Coe-Sullivan, et al, for “Articles For Depositing Materials, Transfer Surfaces, And Methods” filed on 14 Apr. 2006, U.S. Provisional Patent Application No. 60/792,083 of LeeAnn Kim et al., for “Applicator For Depositing Materials And Methods” filed on 14 Apr. 2006, and U.S. Provisional Patent Application No. 60/793,990 of LeeAnn Kim et al., for “Applicator For Depositing Materials And Methods” filed on 21 Apr. 2006. Each of the above-listed provisional patent applications is hereby incorporated herein by reference in its entirety.

Less demanding in thickness control is the technology of optical waveguides and the various functional components which can be made in waveguide form including micro-ring resonators, arrayed waveguide gratings, or Mach-Zehnder interferometers [Thermally tunable micro-ring resonator based optical filters are manufactured by Little Optics. See white papers and specifications at www.littleoptics.com.]. These require precise planar lithography and patterning techniques however.

Semiconductor nanocrystals with small dn/dT for high index superconductors may be useful in, for example, arrayed waveguide gratings, which do not require active temperature stabilization.

The present invention will be further clarified by the following examples, which are intended to be exemplary of the present invention.

### EXAMPLES

### Example 1

### Synthesis of Semiconductor Nanocrystals

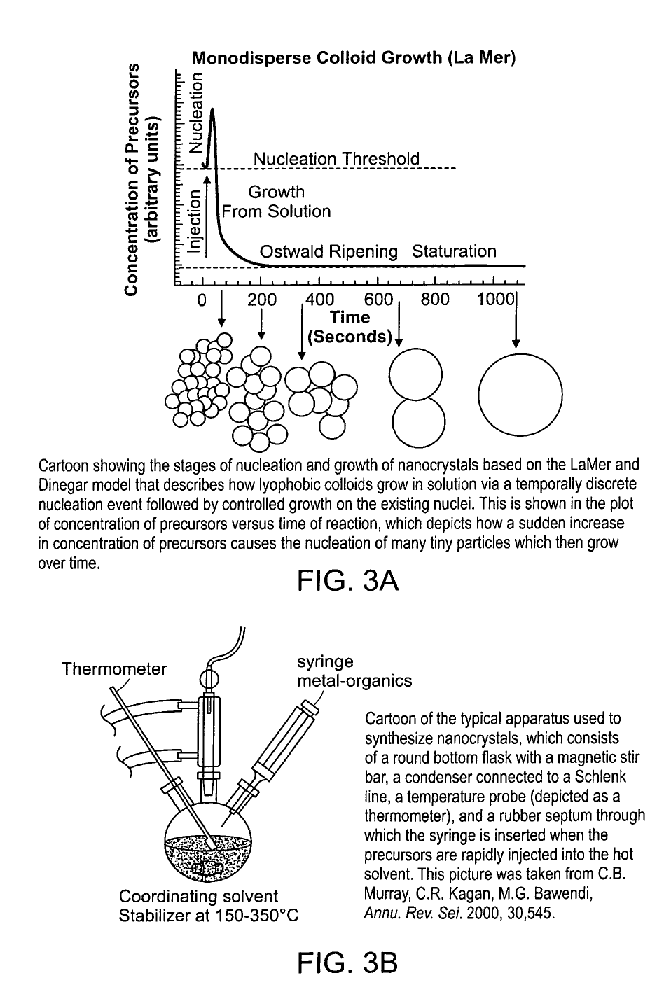

FIG. 3 shows a schematic of the basics of semiconductor nanocrystal synthesis. The preservation of bulk dn/dT properties will be maximized by passivating surface processes and in this regard is analogous to preparing semiconductor nanocrystals for their electroluminescent applications. Colloidal semiconductor nanocrystals are grown in the presence of stabilizing agents to prevent aggregation and precipitation. These stabilizing agents are typically organic molecules or ligands made up of a functional head, like a nitrogen, phosphorous, or oxygen atom, and a long hydrocarbon chain. The functional head of the molecules attaches to the semiconductor nanocrystal surface, preferably as a monolayer, through covalent, dative, or ionic bonds and are referred to as capping groups. This surface capping is analogous to the binding of ligands to metal centers in more traditional coordination chemistry. When molecules are chemically bound to the surface of a semiconductor nanocrystal, they are in part satisfying the bonding requirements of the surface atoms, which eliminates many of the surface traps or surface electronic states and therefore some of the non-radiative relaxation pathways. The direct result of this is that semiconductor nanocrystal samples with good surface passivation have a higher quantum efficiency or quantum yield (QY) than samples with poor surface passivation. Using the right mixture of capping groups during semiconductor nanocrystal synthesis, for example tri-n-octylphosphine and a long chain alkyl amine, provides very good passivation of the surface states and as a result high QYs. When semiconductor nanocrystals lose their capping molecules, QY decreases dramatically. These high boiling organic molecules not only serve to passivate the surface electronic states, but also to mediate semiconductor nanocrystal growth and sterically stabilize the semiconductor nanocrystals in solution.

Close control over semiconductor nanocrystal sizes can produce a narrow range of size distribution as well. The ability to control and separate both the nucleation and growth environments is provided by the choice of organic solvent and capping molecule used. The capping molecules present a steric barrier to the addition of material to the surface of a growing crystallite, which significantly slows the growth kinetics. It is desirable to have enough capping molecules present to prevent uncontrolled nucleation and growth, but not so much that growth is completely suppressed. This synthetic procedure for the synthesis of semiconductor nanocrystals provides a great deal of control and as a result the synthesis can be optimized to give the desired peak wavelength of emission as well as a narrow size distribution. This degree of control is based on the ability to change the temperature of injection, the growth time, the concentration of precursors in solution, the ratio of precursors in solution, and the concentration and type of capping molecules. By changing one or more of these parameters the size of the semiconductor nanocrystals can be tuned across a large range while maintaining a narrow size distribution.

### Example 2

### Preparation of Films and Experimental Fabry-Perot Etalons

The key measurements to be carried out to characterize thermo-optic properties of materials comprising semiconductor nanocrystals are as follows:
Refractive index n
Transmission at 1500 nm
Change in index with temperature, dn/dT

All of these measurements can be accomplished by one basic technique, the fabrication of a simple Fabry-Perot test device including a solid film of semiconductor nanocrystal medium sandwiched between partially reflecting parallel glass or fused silica boundaries. If the medium fills the etalon space, it must be a minimum of ½ wave thick at 1500 nm, which assuming n=4 corresponds to a physical thickness of 188 nm. A simple film of solidified semiconductor nanocrystals will show fringes without any external mirrors, due to the large index contrast between the material and air or glass. Alternatively, an experimental Fabry-Perot can be formed by capturing the film between flat, parallel glass plates which have been coated to be partially reflecting at 1500 nm. The substrates could be fused silica or glass 4″ wafers which are subsequently diced into smaller pieces, microscope slides, or 20 mm diameter optical flats. Precise and parallel spaces between these can be provided by commercially available spacer beads (made for the display industry), at an optical separation of an integral number of half-waves based on the average index (including air space). For example, if the semiconductor nanocrystal solid film is 100 nm thick then spacer beads of diameter 1 μm will provide air space optical thickness of 1000 nm for a total optical thickness of 1400 nm, corresponding to two half-waves near the telecom band. (It is not necessary to measure precisely in the 1530-1560 nm band.) Partially reflecting coatings on the upper and lower substrates in the range R=50-90%, suitable for a low finesse F—P, can be provided by evaporated gold coatings or pre-coated thin film mirrors on glass windows which are commercially available.

Films of solid semiconductor nanocrystals will be deposited onto the lower substrates by spin-casting to achieve solid films of thicknesses approximately 100-200 nm. Based on the concentration of nanocrystals (e.g., PbS) dispersed in the solvent, the thickness of the film can be tuned from one monolayer to hundreds of nm. A goal will be dense films, ranging from a maximum 66% of the bulk density (spherical closest packing) to a more realistic 40% taking into account surface ligand coatings.

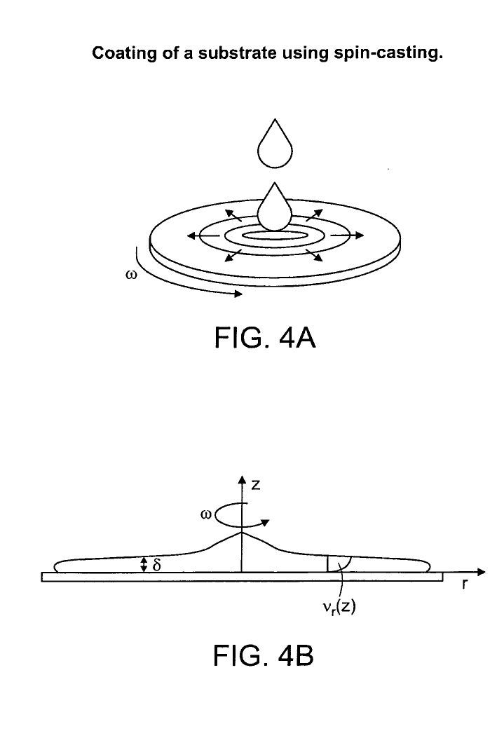

An example of spin-casting a coating is schematically shown in FIG. 4. A solution is dispensed onto a substrate, which rotates at an angular velocity ω=1,000-10,000 rpm. Centrifugal forces spread the solution over the surface, as the solvent evaporates. Spin-casting is often followed by a bake step to drive off any residual solvent and further densify the coating. Better film thickness uniformity across the substrate is obtained for higher ω, but is typically limited to ±100 Å, adequate for initial measurements.

Spin-casting is a fast deposition technique in which a quantity of solid (usually polymer) is dissolved into an organic solvent. This solution is placed onto a substrate, allowed to wet the entire area to be coated, and then set spinning at high speeds (1,000-10,000 rpm is typical). The exact thickness of this liquid film left behind is difficult to predict, but is controlled by a combination of adhesion forces at the substrate/liquid interface, solution viscosity, and friction at the air/liquid interface. For a low vapor pressure solvent, this thin liquid film can exist indefinitely on the spinning substrate surface. However, for typical organic solvents used in spin coating, the vapor pressure is quite high, and the solvent begins to evaporate immediately upon exposure to any unsaturated environment. Thus, this thin liquid film eventually dries (time scales are typically 1-60 s), leaving behind an even thinner (1-1000 nm), flat solid film of the initial solvated solid.

Film surface quality and thickness can be measured in an Atomic Force Microscope (AFM, DI-Veeco Nanoscope III) instrument.

### Example 3

### Characterize for Transmission and Thermo-Optic Effect

Measurements can be carried out in a Cary 5000 vis-IR spectrometer able to measure transmission spectra up to 3 μm.

Initial measurements of film transmission spectra across the visible—near IR range can demonstrate any blue shift of aborptance features as a function of nanocrystal size. Once suitable samples have been selected for in-depth testing, the Fabry-Perot ‘sandwich’ structures described in Example 2 will be fabricated and placed in the Cary sample chamber. These will superimpose on the transmission spectrum a set of Fabry-Perot fringes whose width and spacing will depend on the mirror reflectivities and spacer thicknesses. Using standard Fabry-Perot equations, this data can be analyzed to back out both n and k values, provided k values are not too small. Very small k values comparable to those of Si, k=4×10⁻⁶, are difficult to measure unless a very high finesse Fabry-Perot is produced, or other techniques such as cavity ring-down spectroscopy can be utilized. If k<10⁻³, it will represent at least a two-order improvement over the bulk material.

After measuring n and k, 1/n dn/dT can be measured by heating the experimental Fabry-Perot in a special sample stage, incorporating an arrangement of electric cartridge heaters on which the glass experimental sandwich will be mounted. This heated stage, with thermocouples bonded to track temperature, will then be placed in the sample chamber of the Cary. Temperatures of 100-200° C. should be sufficient to measure dn/dT by observing the shift of Fabry-Perot fringes. Since the Cary provides wavelength resolution on the order of 1 nm, and if the materials are comparable to Si in their thermo-optic effect, a fringe shift of 10 nm is expected over a temperature range 25-125° C., allowing measurement of dn/dT with 10% accuracy. Some routine trial and error with mirror reflectivities and film thicknesses can be expected.

Once basic measurements have been obtained from the Cary spectrometer, more precise measurements in the telecom band can be obtained with a telecom Optical Spectrum Analyzer with resolution 0.01 nm. This will permit observation of much smaller fringe shifts.

It will be apparent to those skilled in the art that various modifications can be made in the methods, articles and systems of the present invention without departing from the spirit or scope of the invention. Thus, it is intended that the present invention cover modifications and variations of this invention provided they come within the scope of the appended claims and their equivalents.

All the patents and publications mentioned above and throughout are incorporated in their entirety by reference herein.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A material comprising nanocrystals of a semiconductor material, wherein the semiconductor material displays thermo-optic effects in bulk form, and the nanocrystals have a size that is sufficiently small to be optically transparent at a predetermined wavelength.

2. A material in accordance with claim 1 wherein the predetermined wavelength is about 1550 nm.

3. (canceled)

4. (canceled)

5. (canceled)

6. (canceled)

7. (canceled)

8. (canceled)

9. (canceled)

10. (canceled)

11. (canceled)

12. A material in accordance with claim 1 having a TOE with a value of at least 30 at room temperature and at 1550 nm freespace optical wavelength.

13. A material in accordance with claim 1 having a 1/n dn/dT value greater than that of silicon.

14. (canceled)

15. (canceled)

16. A tunable thin film optical filter comprising a layer comprising semiconductors nanocrystals, wherein the semiconductor nanocrystals display thermo-optic effects and are sufficiently non-absorbing at a predetermined wavelength so as to be optically transparent at that wavelength.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. A material comprising semiconductor nanocrystals, wherein the semiconductor nanocrystals are capable of displaying thermo-optic effects and are sufficiently non-absorbing at 1550 nm so as to be optically transparent at that wavelength, has a dn/dT at least equal to that of silicon.

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. A material comprising nanocrystals of a semiconductor material, wherein the semiconductor nanocrystals are optically transparent at a predetermined wavelength due to quantum-size effects, the semiconductor material, when in bulk form, is light absorbing at the predetermined wavelength, and the semiconductor nanocrystals display thermo-optic effects greater than those of silicon, while at the same time being transparent at a preselected wavelength of use.

84. (canceled)

85. (canceled)

86. A thin film optical filter comprising a layer comprising semiconductors nanocrystals, wherein the semiconductor nanocrystals possess at least one of the following characteristics:
(a) the semiconductor nanocrystals are optically transparent at a wavelength in the range from about 1500 nm to about 1560 nm,
(b) the semiconductor nanocrystals have a 1/n dn/dt product greater than that of silicon,
(c) the semiconductor nanocrystals have an extinction coefficient, k, less than 10⁻³.

87. A thin film optical filter in accordance with claim 86 wherein the semiconductor nanocrystals possess at least two of the characteristics.

88. A thin film optical filter in accordance with claim in accordance with claim 86 wherein the semiconductor nanocrystals possess three of the above listed characteristics.

89. A thin film optical filter comprising a layer comprising semiconductors nanocrystals, wherein the semiconductor nanocrystals are sufficiently non-absorbing at a predetermined wavelength so as to be transparent at the predetermined wavelength.

90. A tunable thin film optical filter comprising a layer comprising semiconductors nanocrystals, wherein the semiconductor nanocrystals possess at least one of the following characteristics:
(a) the semiconductor nanocrystals are optically transparent at a wavelength in the range from about 1500 nm to about 1560 nm,
(b) the semiconductor nanocrystals have a 1/n dn/dt product greater than that of silicon,
(c) the semiconductor nanocrystals have an extinction coefficient, k, less than 10⁻³.

91. A tunable thin film optical filter in accordance with claim 90 wherein the semiconductor nanocrystals possess at least two of the characteristics.

92. A tunable thin film optical filter in accordance with claim in accordance with claim 90 wherein the semiconductor nanocrystals possess three of the above listed characteristics.

93. (canceled)

94. (canceled)

95. (canceled)

96. A material in accordance with claim 1 wherein the nanocrystals have an average diameter>3 nm.

97. (canceled)

98. A material which possesses at least two of the following characteristics:
(a) is optically transparent at a wavelength in the range from about 1500 nm to about 1560 nm,
(b) has a 1/n dn/dt greater than that of silicon,
(c) has an extinction coefficient, k, less than 10⁻³.

99. A material in accordance with claim 98 wherein the material comprises semiconductor nanocrystals.

100. A method material in accordance with claim 98 wherein the material comprises colloidally synthesized inorganic semiconductor nanocrystals.

101. (canceled)

102. (canceled)

103. A tunable thin film optical filter in accordance with claim 16 wherein the material has TOE with a value of at least 30.

104. A tunable thin film optical filter in accordance with claim 16 wherein the material has a 1/n dn/dT value greater than that of silicon.

105. A tunable thin film optical filter in accordance with claim 16 wherein the filter also comprises a heater film.

106. A tunable thin film optical filter in accordance with claim 16 wherein the predetermined wavelength is about 1550 nm.
